(19) United States
(12) Patent Application Publication
(10) Pub. No.: US 2010/0204837 A1
(43) Pub. Date: Aug. 12, 2010

(54) CLIMATE CONTROL SYSTEM FOR THE ROOMS OF BUILDINGS

(76) Inventor: Jan Rybon, Praha (CZ)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/666,792

(22) PCT Filed: Jun. 18, 2008
(86) PCT No.: PCT/CZ08/00070

§ 371 Date: Apr. 7, 2010

(30) Foreign Application Priority Data
Jul. 4, 2007 (CZ) PV 2007-452

(51) Int. Cl. G05B 15/00; F25B 29/00; F28D 15/00; F28D 5/02

(52) U.S. Cl. 700/278; 165/48.1; 165/104.19; 165/115

(57) ABSTRACT

Climate control system for the rooms of buildings, where the air is treated by cooling, wherein a cooling tank (2) is in the upper part of the room to be cooled and is connected to water consumers (6).

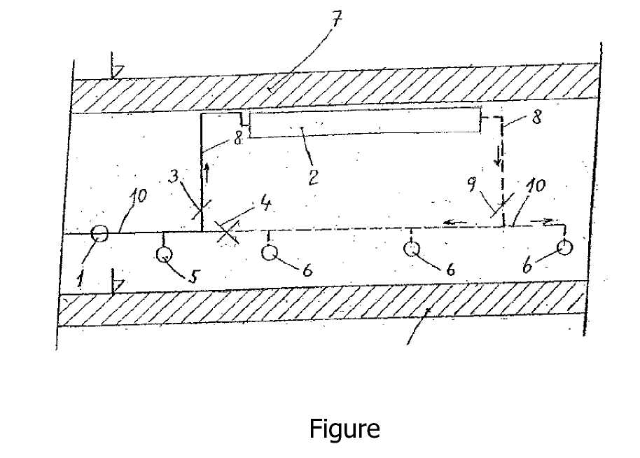

### SCOPE OF THE TECHNOLOGY

The invention relates to climate-control systems for residences, family homes, businesses, and similar spaces where the air is treated by cooling.

### PRIOR ART

There are many costly systems for producing cold, fans that provide the cold from cool areas, and various substances are put into the air flowing into the air conduits. The cooling units have a high energy consumption and demand a lot of attention.

### PRINCIPLE OF THE INVENTION

The principle of the invention is the different weights of hot and cold air and the difference between the water temperature in the water line and the air temperature during the cooling. In the cooled room, the warm/lighter air is in the upper part of the cooled room and the cooler/heavier air is in the bottom part of the cooled room. The cooling tank 2 with the cold water from the water line, located in the upper part of the room, cools the surrounding air, which becomes heavier and sinks downward, and the warm air from the surroundings flows to replace it, which provides for a silent flow of air without adding energy. The inflow of fresh cold water into the cooling tank 2 causes the heated water to be taken up by the consumers 6. The heated water is fed to the water consumers 6 for washing, bathing, or where the heated water saves the energy for heating it. This climate-control system is simple, and its operation requires no material and no energy.

### EXAMPLE OF IMPLEMENTATION OF THE INVENTION

The climate-control system pursuant to the invention is intended for cooling one or more rooms, or for all rooms in the building, as the case may be. Therefore, the water supply system in the climate-control system depends on the number and sizes of the cooled rooms, on the number of cooling tanks, on their sizes, etc. Therefore, the FIGURE shows a general diagram.

The system pursuant to the FIGURE consists of the water line 10 with the consumers 6 of the heated water, with the shutoff 4 and the connection through the shutoff 1 to the municipal water main. A parallel water line 8 with shutoff 3 is connected to this water line 10, with connected water tanks, shown schematically, that are located on the ceiling 7. For the water line 10 and for the parallel water line 8, the cold water is shown by a solid line and the heated water is shown by a broken line. The flow of water is indicated by arrows.

After closing the shutoff 4 and opening the shutoff 3, the air is cooled. Because of this, the cold water flows out of the municipal main or the in-house main into the parallel water line 8. The water flows through the cooling tank 2 and the heated water flows through the water lines 8 and 10 to the consumers 6 of heated water, for example in the bathroom, in the kitchen, or to the outdoor shower. Multiple water lines can be laid in parallel in a building.

The connection between the shutoffs can be made with tubing, a pipe, containers, or in other ways, according to the state of the art.

In a way familiar to a person skilled in the art, many shutoffs can be assembled in series with appropriate technology into a whole according to the diagram of the invention shown, for example for different sizes of residences.

The cooling tank 2, or possibly a group of cooling tanks 2, is installed on the ceiling 7. It can advantageously be suspended on the plumbing conduit. The cooling tank 2 can have the form of a radiator, a long pipe, or other form, depending on the nature of the cooled room. In a moist cooled room, for example in the kitchen, the cooling tank 2 according to the invention and with regard to the condensed water can be made differently by evaporation surfaces or by tapping off this water. The flow of air can be corrected with fans if necessary.

The climate-control system pursuant to the invention can be regulated manually, by remote control, automatically according to the temperature of the cooled air, or otherwise. The climate-control system can be equipped with emission shutoffs.

1-8. (canceled)

9. A climate-control system in a room of a building, characterized in that this system comprises a cooling tank in the form of a heat exchanger and a water consumer, wherein the cooling tank is filled with water from a municipal water main and is fastened in the upper half of the room of the building, with the water consumer being connected to the cooling tank so that water flows out of the cooling tank through the water consumer, and water from the municipal water main then flows correspondingly into the cooling tank.

10. The climate-control system pursuant to claim 9, further characterized in that the climate-control system is fed into a water consumer.

11. The climate-control system pursuant to claim 9, further characterized in that there are multiple cooling tanks.

12. The climate-control system pursuant to claim 9, further characterized in that the cooling tank is in the area of the ceiling.

13. The climate-control system pursuant to claim 9, further characterized in that the cooling tank has the form of a radiator, pipes, or a body according to the nature of the cooled room, and its lower part can be empty, with its surface serving as an evaporation surface for the condensed water dripping from the cooling upper part.

14. The climate-control system pursuant to claim 9 further characterized in that the climate-control system according to the invention cools one, more than one, or all of the rooms of the building.

15. The climate-control system pursuant to claim 9, further characterized in that multiple shutoffs or all shutoffs are assembled in advance in series, depending on the size and type of the rooms being cooled.

16. The climate-control system pursuant to claim 9, further characterized in that multiple shutoffs or all shutoffs are regulated remotely or automatically according to the temperature of the cooling air.
